(19) United States
(12) Patent Application Publication
(10) Pub. No.: US 2009/0128966 A1
(43) Pub. Date: May 21, 2009

(54) MAGNETIC MEMORY CELL BASED ON A MAGNETIC TUNNEL JUNCTION(MTJ) WITH LOW SWITCHING FIELD SHAPES

(76) Inventors: Krishnakumar Mani, San Jose, CA (US); Jannier Maximo Roiz Wilson, Santa Clara, CA (US)

Correspondence Address: HAHN AND MOODLEY, LLP, P.O. BOX 52050, MINNEAPOLIS, MN, 55402, US

(21) Appl. No.: 12/249,897

(22) Filed: Oct. 10, 2008

Related U.S. Application Data
(60) Provisional application No. 60/979,046, filed on Oct. 10, 2007.

(51) Int. Cl. G11B 5/33

(52) U.S. Cl. 360/324.2

(57) ABSTRACT

Embodiments of the invention magnetic memory device, comprising: a magnetic tunnel junction (MTJ) which includes a Magnetic Tunnel Junction (MTJ) stack which has one of a crescent-shaped profile and an elbow-shaped profile in cross-section.

This application claims the benefit of priority to U.S. Provisional Patent Application No. 60/979,046 filed Oct. 10, 2007, the entire specification of which is incorporated herein by reference.

### FIELD

Embodiments of the invention relate to magnetic memory cells and devices built using magnetic memory cells.

### BACKGROUND

A magnetic random access memory (MRAM) cell generally comprises a stack of several layers, some of which are composed of ferromagnetic material. Normally, MRAM cells have two stable magnetization configurations that can be selected by rotating the magnetization from one configuration to the other. Each configuration represents either a memory state “1” or a “0”. To write information in a cell, a memory device must be able to switch the cell magnetization between these two states. The magnitude of the magnetic field required to switch the cell from one stable state to the other is referred to as the switching field. The switching field is a function of the shape of the materials, the dimensions, and the layer configuration of the cell. In general, as cell dimensions are reduced the switching field increases, provided that thermal stability is kept at the same level.

MRAM cells generally have a rectangular or elliptical shape, as seen from top to bottom.

### SUMMARY OF THE INVENTION

Embodiments of the invention magnetic memory device, comprising: a magnetic tunnel junction (MTJ) which includes a Magnetic Tunnel Junction (MTJ) stack which has one of a crescent-shaped profile and an elbow-shaped profile in cross-section.

Other aspects of the invention will be apparent from the detailed description below:

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings, wherein:

FIG. 1 shows a schemetic drawing of a prior art Magnetic Tunnel Junction (MTJ) stack.

FIG. 2 shows plan views of cross-sectional shapes for a MTJ stack, in accordance with embodiments of the invention.

FIG. 3 shows a three-dimensional view of a MTJ stack with a crescent-shaped cross section, in accordance with one embodiment of the invention.

FIGS. 4 and 5 show the cross-sectional dimensions for a MTJ stack in accordance with one embodiment of the invention.

FIG. 6 shows a synthetic antiferrmagnet (SAF) layer that may comprise a free layer for a MTJ stack, in accordance with one embodiment of the invention.

FIG. 7 shows the switching mechanism for cells with crescent and elbow-shaped MTJ stack cross sections, in accordance with one embodiment of the invention.

FIG. 8 shows a MRAM array exemplified as a 3×3 memory cell array with an access transistor for each cell.

FIG. 9 shows a MRAM array exemplified as a 3×3 memory cell array with a vertical diode for each cell.

FIG. 10 shows an electrical drawing for a MRAM array, in accordance with the invention.

FIG. 11 shows a block diagram of a computer device, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

A magnetic tunnel junctions (MTJ) may be used as a magnetic element in a MRAM cell as the basic element or magnetic bit to store data. The physics of MTJ MRAM cells can be found in the publication: M. Durlam, P. Naji, M. DeHerrera, S. Tehrani, G. Kerszykowski, and K. Kyler, “Nonvolatile RAM based on Magnetic Tunnel Junction Elements”, ISSCC Digest of Technical Papers, p.130, (February 2000), which is hereby incorporated by reference.

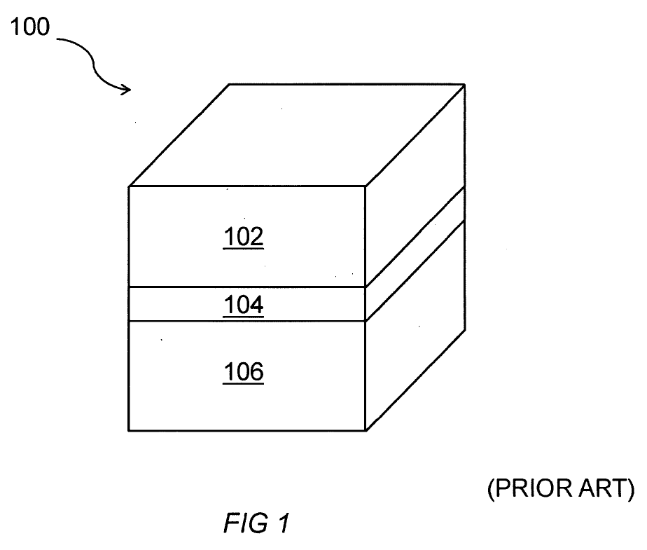

As is known to one of ordinary skill in the art, a MTJ may be realized as a stack of materials or layers. A prior art MTJ stack 100 is shown in FIG. 1 of the drawings. As will be seen the stack 100 includes a fixed magnetic layer 102, a tunnel oxide layer 104 and a free magnetic layer 106. The stack 100 has a rectangular cross-section. Each layer/structure may itself comprise several layers. For example, the fixed and/or the free magnetic layer can be a three-layer synthetic antiferromagnet (SAF), as described for example in K. Inomata, N. Koike, T. Nozaki, S. Abe, and N. Tezuka, “Size-independent spin switching field using synthetic antiferromagnets,” Appl. Phys. Lett., vol. 82, no. 16, p. 2667 (2003), which is hereby incorporated by reference. In some cases, the fixed magnetic layer 102 may also comprise an antiferromagnetic layer, e.g. IrMn or PtMn to help fix the magnetization in the fixed layer. This magnetization does not switch to another stable configuration under normal conditions of temperature and magnetic field going through the layer. As used herein, the word ‘normal’ refers to the usual conditions and circumstances to which a memory device may be exposed in ordinary use. The magnetization in the free magnetic layer 106 can be rotated either with the assistance of an external magnetic field or by spin transfer mechanism. Description of the spin transfer mechanism can be found in the following publications: J. C. Slonczewski, “Current-Driven Excitation of Magnetic Multilayers”, Journal of Magnetism and Magnetic Materials, vol. 159, p. L1 (1996); L. Berger, “Emission of spin waves by a magnetic multilayer traversed by a current”, Phys. Rev. B, vol. 54, p. 9353 (1996), and F. J. Albert, J. A. Katine and R. A. Buhrman, “Spin-polarized Current Switching of a Co Thin Film Nanomagnet”, Appl. Phys. Lett., vol. 77, No. 23, p. 3809 (2000), each of which is hereby incorporated by reference.

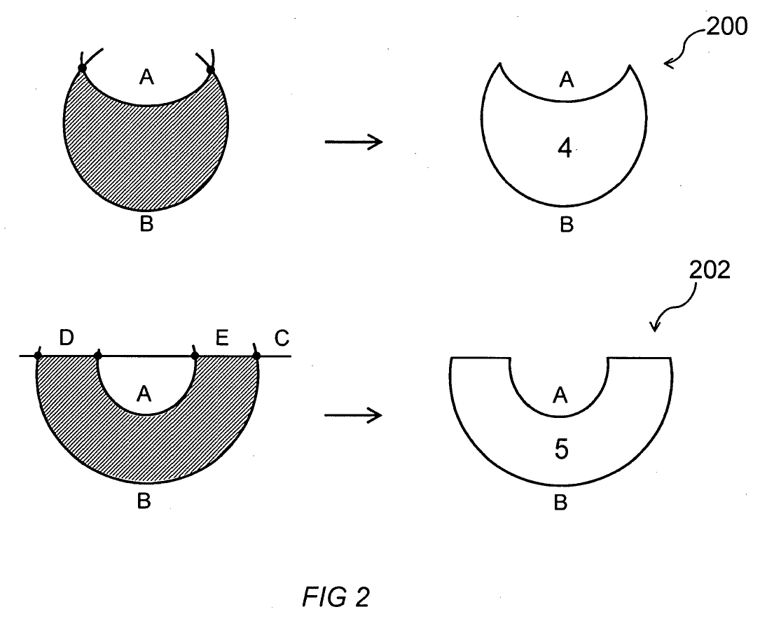

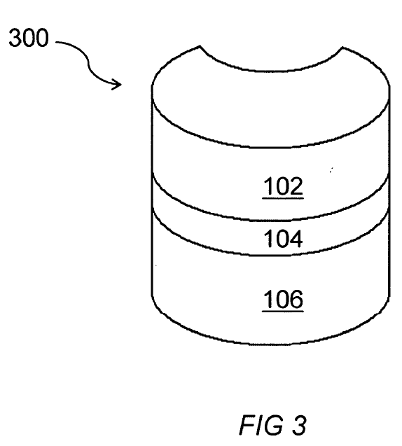

Embodiments of the present invention disclose two different and novel shapes for a MTJ stack. A top plan view representation of these shapes is shown in FIG. 2. As will be seen, the shape 200 is defined by two arcs A and B that intersect at two different points, resulting in a crescent-like figure, whereas the shape 202 is generally elbow shaped, defined by an inner and an outer arcs (A and B, respectively) and a straight segment C that cuts through the arches, resulting in two flat sides D and E. FIG. 3 shows a MTJ stack 300 in which the layers are crescent shaped in cross-section.

Advantageously, MTJ stacks having cross-sections that match the shapes 200 and 202 require a lower switching field than MTJs with rectangular or elliptical shape of similar dimensions, all other things being equal.

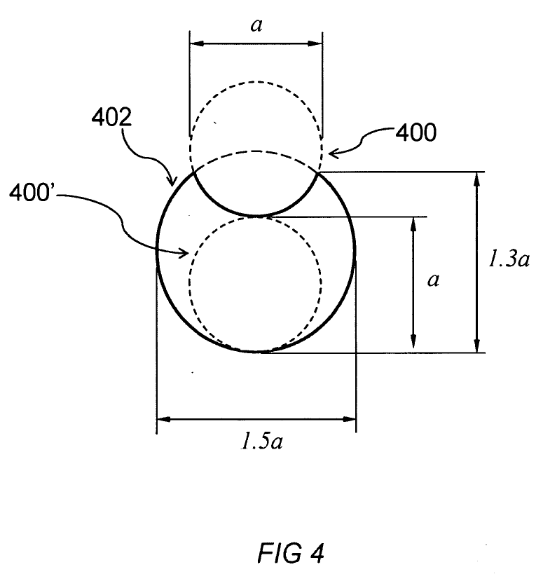

In one embodiment to arrive at the cross-sectional shape 200 for a MTJ stack, two small circles 400 and 400′ are positioned as shown in FIG. 4. Then a large circle 402 is positioned as shown. The crescent shape 200 is obtained by subtracting a the circle 400 from a larger circle 400 from the large circle 400. In FIG. 4, the small circles have a diameter of a and the large circle has a diameter of 1.3 a.

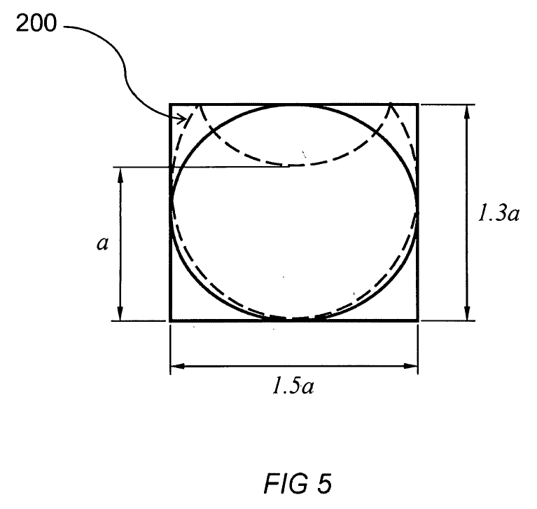

Referring now to FIG. 5 of the drawings, there is shown the general dimensions for a crescent shape 200, in accordance with another embodiment of the invention.

In one embodiment, a MTJ stack of the present invention in addition to having a crescent or elbow shaped cross section as described, may also have its free layer 106 comprised of a very soft magnetic material with saturation magnetization below 10⁶ A/m, such as NiFe alloys. In one embodiment the thickness of the free layer 106 may be between 20 A and 40 A.

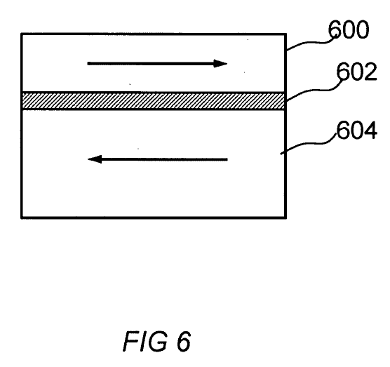

On another embodiment, for very soft magnetic materials with saturation magnetizations higher than 10⁶ A/m, e.g. FeCo or FeCoB alloys, in addition to having a cross-sectional shape corresponding to the shaped 200 and 202, a MTJ may have a synthetic anti-ferromagnet (SAF) as its free layer 106. An example of SAF free layer is shown in FIG. 6. In this case the SAF free layer is composed of two ferromagnetic layers 600 and 604, separated by a spacer layer 602. In one embodiment, the spacer layer 602 may be for example a layer comprising Ru of thickness 8 A, or a Cr layer of thickness 10 A. The ferromagnetic layers 600 and 104 are exchange coupled through the spacer layer 602. In one embodiment, the ferromagnetic layer 604 is thicker than the layer 600. In one embodiment the thickness of layers 600 and 604 are 30 A and 60 A, respectively. The magnetizations in the two ferromagnetic layers are oppose each other, as indicated by the opposing arrows.

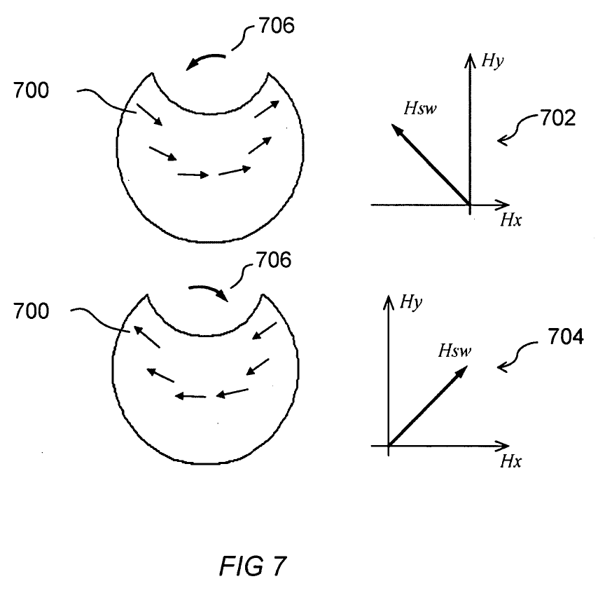

In one embodiment, the stable local magnetization within the free magnetic layer of the inventive MTJ stack has directions following, to some extent, the contours of the stack cross-sectional shape (more so to the edges of the cell). This is schematically shown in FIG. 7 where local magnetization at some points of a free magnetic layer, with the shape 200, is represented with arrows 700. In one embodiment a mechanism for switching cells with shapes 200 and 202 implies supplying a magnetic field with a component in the positive sense of the y axis and a component in the x axis, as schematically represented by diagrams 702 and 704. Diagrams 702 and 704 show the switching field (Hsw). direction for the right-to-left and left-to-right cell switching, respectively. The direction and sense of the rotation of the free layer's net magnetization is shown with arrows 706. Any delay between the applications of the magnetic fields Hx and Hy or separate modulation of these fields is also included within scope of the present invention.

Although the cells herein described hold certain proportions between their different features, one skilled in the art will appreciate that small variations of such proportions or specular reflections of the described cells with respect to any plane are within the scope of the present invention. Accordingly, this description of the invention is set forth without any loss of generality to, and without imposing limitations upon, the invention.

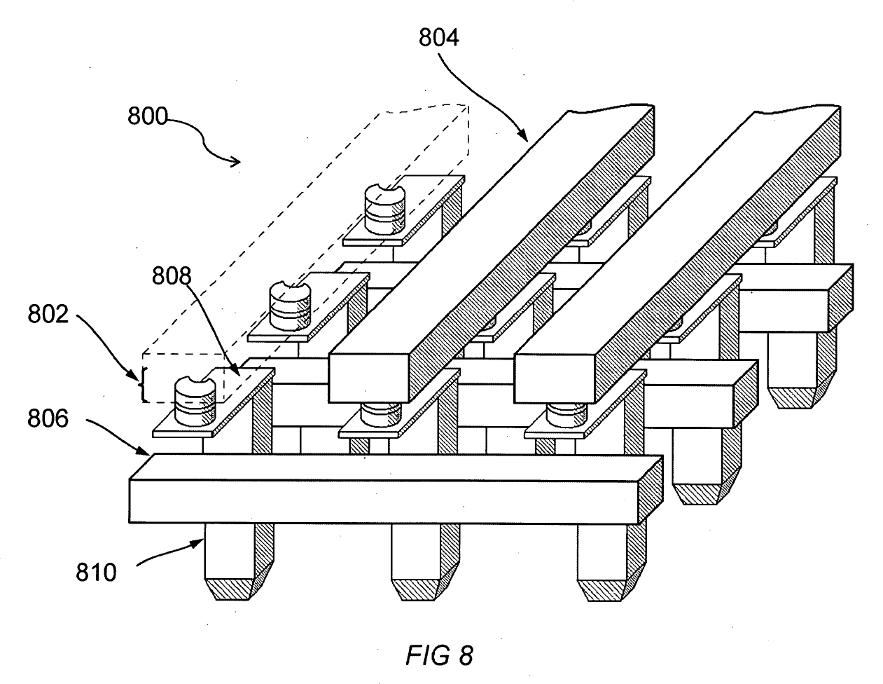

The MTJ stacks described may be used in any MRAM cell configuration. FIG. 8 shows one of such configurations exemplified with a 3×3 memory cell array 800. In FIG. 8, each MRAM cell comprises a MTJ stack 802 of the kind described located between two metal lines 804 and 806. Each MRAM cell has its owns access transistor which has not been shown so as not to obscure the invention. A bottom electrode 808 and a via 810 makes the connection with the access transistor.

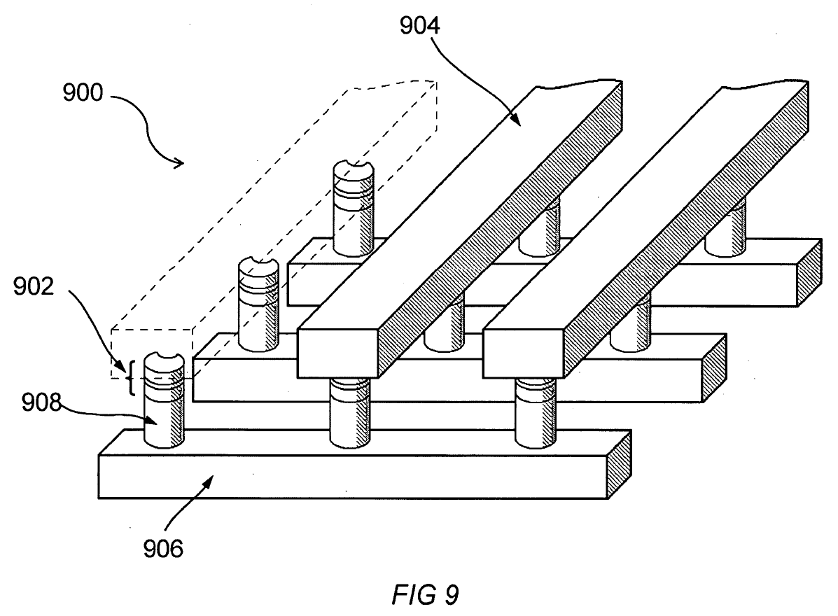

In another embodiment, as exemplified in FIG. 9, a 3×3 memory cell array 900 is disclosed. In the array 900, each MRAM cell 902 is sandwiched between metal lines 904 and 906. However, instead of having an access transistor, each cell 902 has a vertical diode 908 to serve the purpose of selecting each cell individually for reading. A read current goes through metal lines 904 and 906.

Manufacturing MRAM cells with the novel MTJ stacks may accomplished by several methods. For example, the layers of the MTJ cell can be patterned using optical, x-ray, electron-beam or ion-beam lithography techniques or nanoimprint, deposition can be done using thin film sputtering techniques while the etching/patterning can be done using established etching and ion milling techniques. Metal line interconnects can be manufactured with established back-end processes. Logic and read/write circuitry can be manufactured with standard CMOS processes. One skilled in the art would be aware of the requirements and specificities of the techniques mentioned above for the purpose of fabricating an MRAM device. The mentioning of specific manufacturing techniques in this manuscript should not be interpreted as a limit on the ways the invention can be manufactured.

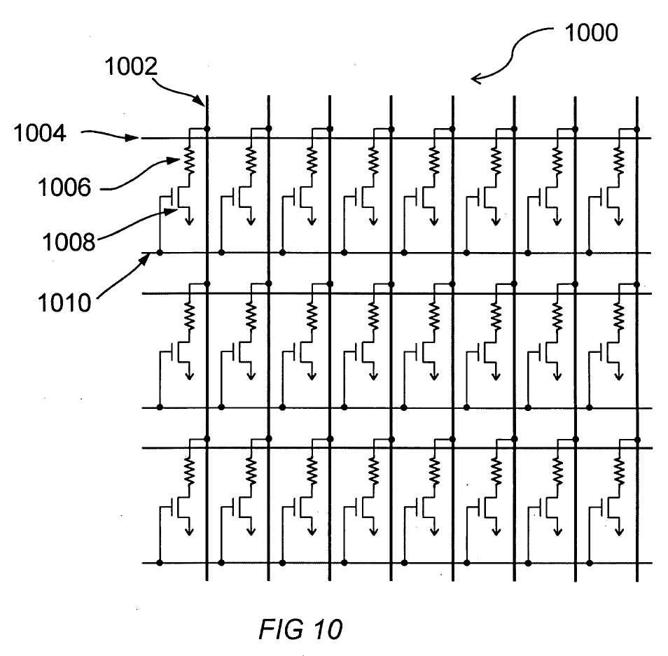

FIG. 10 shows the electical layout of a MRAM array 1000 in accordance with one embodiment of the invention. As will be seen the layout comprises a plurality of intersection bit lines 1002 and word lines 1004. At each intersection of a bit line 1002 and a word line 1004 there is located a MRAM cell indicated schematically as a resistance 1006. Each MRAM cell includes the novel MTJ stack described, and thus will enjoy a lower switching field to toggle its magnetic bit. Each MRAM cell forming a word has its own access transistor 1008. The access transistors 1008 along a word connect to a common read word line 1010.

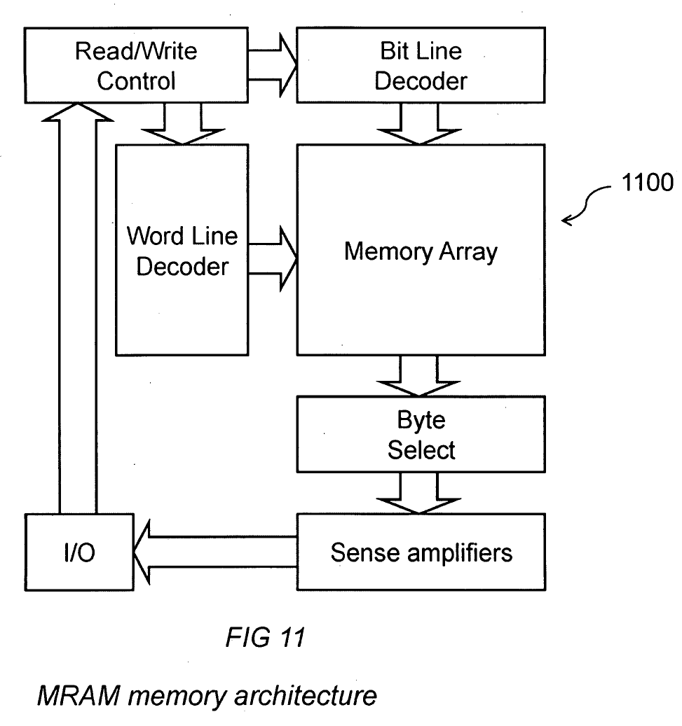

Embodiments of the invention also extend to a computer device that includes a MRAM memory that employs the novel MTJ stack described. FIG. 11 of the drawings shows a block diagram on for such a computer device 1100. As can be seen the computer device includes a memory 1102. The memory 1102 is a MRAM device comprising MRAM cells, each having the novel MTJ stack described.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A magnetic element, comprising:
a Magnetic Tunnel Junction (MTJ) stack which has one of a crescent-shaped profile and an elbow-shaped profile in cross-section.

2. The magnetic element of claim 1, wherein the MTJ stack comprises a free layer that defines a synthetic anti-ferromagnet (SAF).

3. The magnetic element of claim 2, wherein the MTJ stack comprises a magnetic material with saturation magnetization above 10⁶ A/m.

4. The magnetic element of claim 1, wherein the MTJ stack comprises a magnetic material with saturation magnetization below 10⁶ A/m.

5. The magnetic element of claim 4, wherein the free layer comprises a NiFe alloy.

6. The magnetic element of claim 4, wherein a thickness of the free layer is between 20 A and 40 A.

7. A magnetic memory cell, comprising:
a Magnetic Tunnel Junction (MTJ) stack which has one of a crescent-shaped profile and an elbow-shaped profile in cross-section.

8. The magnetic memory cell of claim 7, wherein the MTJ stack comprises a free layer that defines a synthetic anti-ferromagnet (SAF).

9. The magnetic memory cell claim 8, wherein the MTJ stack comprises a magnetic material with saturation magnetization above 10⁶ A/m.

10. The magnetic memory cell of claim 7, wherein the MTJ stack comprises a magnetic material with saturation magnetization below 10⁶ A/m.

11. The magnetic memory cell of claim 10, wherein the free layer comprises a NiFe alloy.

12. The magnetic memory cell of claim 10, wherein a thickness of the free layer is between 20 A and 40 A.

13. A magnetic memory array, comprising:
a plurality of magnetic memory cells, each comprising a Magnetic Tunnel Junction (MTJ) stack which has one of a crescent-shaped profile and an elbow-shaped profile in cross-section.

14. The magnetic memory array of claim 13, wherein the MTJ stack comprises a free layer that defines a synthetic anti-ferromagnet (SAF).

15. The magnetic memory array claim 14, wherein the MTJ stack comprises a magnetic material with saturation magnetization above 10⁶ A/m.

16. The magnetic memory array of claim 13, wherein the MTJ stack comprises a magnetic material with saturation magnetization below 10⁶ A/m.

17. The magnetic memory array of claim 16, wherein the free layer comprises a NiFe alloy.

18. The magnetic memory array of claim 16, wherein a thickness of the free layer is between 20 A and 40 A.

19. A computer device, comprising:
magnetic memory which includes a plurality of magnetic memory cells, each comprising a Magnetic Tunnel Junction (MTJ) stack which has one of a crescent-shaped profile and an elbow-shaped profile in cross-section.

20. The computer device of claim 19, wherein the MTJ stack comprises a free layer that defines a synthetic anti-ferromagnet (SAF).
